(19) United States
(12) Patent Application Publication
(10) Pub. No.: US 2023/0108861 A1
(43) Pub. Date: Apr. 6, 2023

(54) FISHING POLE APPARATUS AND METHODS OF USING THE SAME

(71) Applicant: David Battershell, Antioch, IL (US)

(72) Inventor: David Battershell, Antioch, IL (US)

(21) Appl. No.: 17/959,882

(22) Filed: Oct. 4, 2022

Related U.S. Application Data
(60) Provisional application No. 63/251,914, filed on Oct. 4, 2021.

(51) Int. Cl. A01K 87/00; A01K 87/04

(52) U.S. Cl. CPC A01K 87/008; A01K 87/04

(57) ABSTRACT

Fishing pole improvements to the fishing line guides attached to the shaft of the fishing pole are provided. In addition, the present invention provides improvements to the handle, namely offsetting the handle from the shaft of the pole.

### CROSS-REFERENCE TO RELATED APPLICATIONS

The present invention claims priority to U.S. Prov. Pat. App. No. 63/251,914, titled, “Fishing Pole Improvements,” filed Oct. 4, 2021, which is incorporated herein by reference in its entirety.

### TECHNICAL FIELD

The present invention relates to fishing pole improvements. Specifically, the present invention provides improvements to the fishing line guides attached to the shaft of the fishing pole. In addition, the present invention provides improvements to the handle, namely offsetting the handle from the shaft of the pole.

### BACKGROUND

A fishing pole typically has several features that allow the fishing line to be cast into a body of water, typically with a hook and some type of bait to hook a fish or other sea creature. The fishing line, generally, extends from a reel down a shaft of a pole, disposed through a plurality of guides to the tiptop of the pole, whereupon the fishing line extends into the body of water, having a hook, bait, some kind of attractant, weights, or other like elements designed to aid in hooking a fish or other sea creature.

The guides are typically ringlets that extend from the shaft of the pole at intervals along the length of the shaft. Typically, these ringlets are much larger than the fishing line itself. Generally, the ringlets are designed to hold the fishing line in a linear manner from the reel to the tiptop of the shaft but can be relatively large to allow easy stringing of the fishing line through each of the ringlets.

Oftentimes, however, a fisherman must pay close attention to movement of the fishing line to determine whether he or she has hooked a fish, or whether, more importantly, a fish is testing bait. Specifically, a fisherman can often actively hook a fish if he or she knows that a fish is testing the hook or the bait. However, because of the large amount of space within the ringlets of a fishing pole, it is often difficult to gauge precise movements of the fishing line due to testing of the hook and/or bait by the fish. A need, therefore, exists for an improved fishing pole. Specifically, a need exists for an improved fishing pole providing more precise fishing line movements when a fish is testing a hook or bait.

Moreover, a typical fishing pole generally has a handle that is typically in line with or very closely in line with the longitudinal shaft. Oftentimes, a handle is simple an extension of the shaft of the pole. As a fisherman holds a pole, he or she can often use vibrations of the shaft, especially the tiptop of the shaft, to gauge whether there is interest from a fish. However, a handle that extends in line or extends closely in line with a shaft may make it difficult to properly gauge the interest of a fish on a hook and/or bait. A need, therefore, exists for an improved handle of a fishing pole. Specifically, a need exists for an improved handle that allows for more precise gauging of fish interest on a hook and/or bait.

### SUMMARY OF THE INVENTION

The present invention relates to fishing pole improvements. Specifically, the present invention provides improvements to the fishing line guides attached to the shaft of the fishing pole. In addition, the present invention provides improvements to the handle, namely offsetting the handle from the shaft of the pole.

To this end, in an embodiment of the present invention, an improved fishing pole is provided. The fishing pole comprises a rod having a first end and a second end, a handle, a reel comprising fishing line near a first end of the rod, and at least a first tube attached on a side of the rod in a first location between the reel and a tip of the rod at the second end thereof.

In an embodiment, the first tube is attached on the side of the rod at the tip of the rod.

In an embodiment, the length of the first tube is longer than the diameter of the first tube.

In an embodiment, the fishing pole further comprises: a second tube attached on a side of the rod in a second location between the reel and the top of the rod.

In an embodiment, the first tube and the second tube are aligned longitudinally with each other.

In an embodiment, the fishing line runs through the first tube.

In an embodiment, the fishing lines through the first tube and the second tube.

In an embodiment, the fishing pole further comprises: a plurality of tubes attached to a side of the rod in locations between the reel and the tip of the rod.

In an embodiment, the plurality of tubes are aligned longitudinally with each other.

In an embodiment, the fishing line runs through each of the plurality of tubes.

In an embodiment, the first tube comprises at least one flared end.

In an embodiment, the first tube comprises a first flared end and a second flared end.

In an alternate embodiment of the present invention, a method of using a fishing pole is provided. The method comprises the steps of: providing a rod having a first end and a second end, a handle, a reel comprising fishing line near a first end of the rod, and at least a first tube attached on a side of the rod in a first location between the reel and a tip of the rod at the second end thereof; feeding the fishing line from the reel through the first tube; and fishing with the fishing pole.

In an embodiment, the first tube is attached to the side of the rod at the tip thereof.

In an embodiment, the length of the first tube is larger than the diameter of the first tube.

In an alternate embodiment of the present invention, a fishing pole is provided. The fishing pole comprises: a first rod portion comprising a handle for holding the fishing pole; a rod extension extending at a first angle from the first rod portion, the rod extension having a length; a second rod portion extending from an end of the rod extension, the second rod portion extending at a second angle from the rod extension; and a reel having fishing line attached to the second rod portion.

In an embodiment, the first rod portion and the second rod portion are roughly parallel to each other.

In an embodiment, the rod extension extends from the first rod portion at an angle of ninety degrees or less.

In an embodiment, the fishing pole further comprises: at least a first tube attached on a side of the rod in a first location between the reel and a tip of the rod at the second end thereof.

In an embodiment, the first tube has a length that is larger than a diameter of the first tube.

It is, therefore, an advantage and objective of the present invention to provide an improved fishing pole.

Specifically, it is an advantage and objective of the present invention to provide an improved fishing pole providing more precise fishing line movements when a fish is testing a hook or bait.

Moreover, it is an advantage and objective of the present invention to provide an improved handle of a fishing pole.

Specifically, it is an advantage and objective of the present invention to provide an improved handle that allows for more precise gauging of fish interest on a hook and/or bait.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a fishing pole in an embodiment of the present invention.

FIG. 2 illustrates a perspective view of a shaft of a fishing pole with fishing line guides in an embodiment of the present invention.

FIG. 3 illustrates a close-up view of a fishing line guide on a shaft in an embodiment of the present invention.

FIG. 4 illustrates a close-up view of an improved handle of a fishing pole in an embodiment of the present invention.

### DETAILED DESCRIPTION OF THE PRESENTLY PREFERRED EMBODIMENTS

The present invention relates to fishing pole improvements. Specifically, the present invention provides improvements to the fishing line guides attached to the shaft of the fishing pole. In addition, the present invention provides improvements to the handle, namely offsetting the handle from the shaft of the pole.

Referring now to the drawings, the present invention comprises an improved fishing pole. Specifically, the present invention provides an improved guides for guiding fishing line along a shaft of the fishing pole, and an improved handle that allows for more precise determining whether a fish is hooked or testing a hook and/or bait. Although the figures show an ice-fishing pole, it should be noted that the improvements discussed and shown herein may be provided to any fishing pole, and the invention should not be limited as shown and described herein.

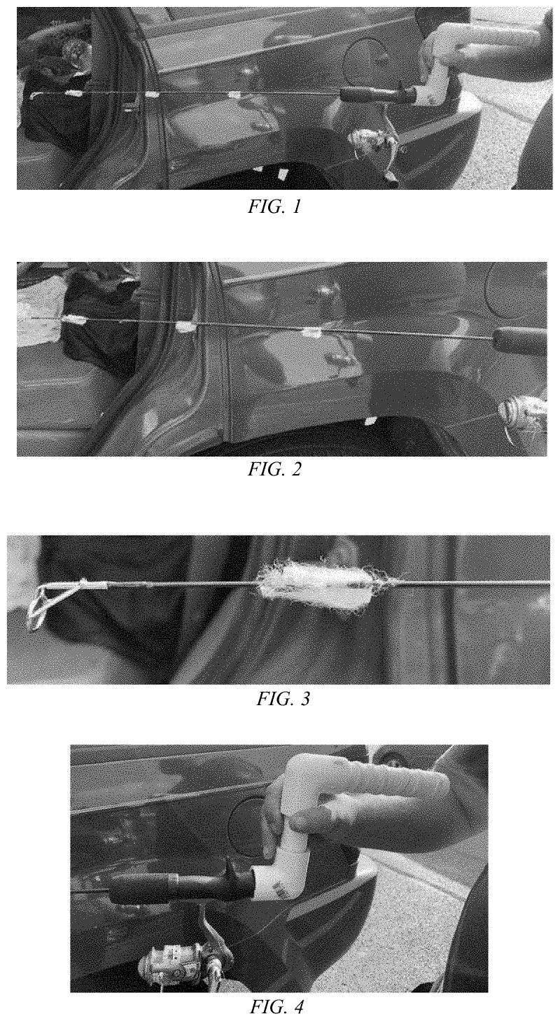

The guides of the fishing pole, as illustrated more precisely in FIGS. 1-3, may comprise a plurality of tubes extending from the shaft of the fishing pole. The tubes may have diameters much smaller than typical ringlet guides on a typical fishing pole. Indeed, the tubes may be barely wider than the width of the fishing line, thereby holding the fishing line through the tubes and preventing the fishing line from bouncing wildly, especially when a fish is testing a hook and/or bait.

Preferably, each tube may have a length disposed and attached longitudinally on a side of the fishing pole. Typically, the length of the tube may be larger than the width of the tube, which may vary in size, but may be relatively small to prevent the fishing line from bouncing wildly when a fish is testing the hook or bait, as described above. The width may typically be the diameter of the tube.

As illustrated in the figures, a plurality of tubes may be provided at intervals along the shaft and take the place of traditional ringlets. Alternatively, one or more tubes may be provided in place of just one or more ringlets, and other ringlets may remain, such that the shaft of the fishing pole has a series of ringlets and tubes providing guidance to the fishing line in conjunction with each other. Also, the tubes may run inside the shaft of the fishing pole itself, without any apparent tubes on the outside thereof.

As illustrated in the figures, tubes may extend from the shaft at intervals along the shaft and a ringlet may be provided at the tiptop of the shaft; therefore, while the guides may limit the motion of the fishing line laterally within the tubes, there still may be provided freedom of movement of the fishing line at the tiptop thereof, so that the fishing line may be more easily viewed and whether a fish is testing a hook and/or bait may be more easily determined. The tubes may minimize movement of the fishing line due to other factors besides a fish testing the hook and/or bait thereof. The tubes may extend from the shaft of the pole, as shown in the figures or may be embedded either very closely to the shaft or within the shaft itself.

In addition, the tubes themselves may have a flare end or flared ends allowing easier access to the inside of the tubes, such as for painting or marking or the like. In addition, flaring the ends may provide a smoother movement of the line through the tubes, decreasing the surface area that may contact the fishing line that runs therethrough.

In an alternate embodiment of the present invention, illustrated in FIGS. 1 and 4, a grip or handle may be provided having a longitudinal shaft that is offset from the shaft of the fishing pole. Specifically, the pole may have an extended element that extends roughly at an angle from the longitudinal length of the shaft, and a grip or handle that is therefore offset but roughly parallel to the longitudinal length of the shaft. For example, as illustrated in FIGS. 1 and 4, an extension may extend roughly ninety degrees from the shaft, wherein the grip or handle may extend roughly ninety degrees from the extension, providing a handle that is offset and parallel to the shaft. The extension may extend at any angle, however, and may further be curved for aesthetics.

By utilizing the offset grip or handle, as illustrated in FIGS. 1 and 4, a user may notice movement of the tiptop better. Specifically, as a fish tests a hook and/or bait, holding the fishing pole by the offset grip or handle provides more movement at the tiptop of the shaft, as there is more torque of the tiptop from movements of the hook and/or bait caused by testing fish thereof relative to the grip or handle.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A fishing pole comprising:
a rod having a first end and a second end, a handle, a reel comprising fishing line near a first end of the rod, and at least a first tube attached on a side of the rod in a first location between the reel and a tip of the rod at the second end thereof.

2. The fishing pole of claim 1 wherein the first tube is attached on the side of the rod at the tip of the rod.

3. The fishing pole of claim 1 wherein the length of the first tube is longer than the diameter of the first tube.

4. The fishing pole of claim 1 further comprising:
a second tube attached on a side of the rod in a second location between the reel and the top of the rod.

5. The fishing pole of claim 4 wherein the first tube and the second tube are aligned longitudinally with each other.

6. The fishing pole of claim 1 wherein the fishing line runs through the first tube.

7. The fishing pole of claim 4 wherein the fishing lines through the first tube and the second tube.

8. The fishing pole of claim 1 further comprising:
a plurality of tubes attached to a side of the rod in locations between the reel and the tip of the rod.

9. The fishing pole of claim 8 wherein the plurality of tubes are aligned longitudinally with each other.

10. The fishing pole of claim 8 wherein the fishing line runs through each of the plurality of tubes.

11. The fishing pole of claim 1 wherein the first tube comprises at least one flared end.

12. The fishing pole of claim 1 wherein the first tube comprises a first flared end and a second flared end.

13. A method of using a fishing pole comprising the steps of:
providing a rod having a first end and a second end, a handle, a reel comprising fishing line near a first end of the rod, and at least a first tube attached on a side of the rod in a first location between the reel and a tip of the rod at the second end thereof;
feeding the fishing line from the reel through the first tube; and
fishing with the fishing pole.

14. The method of claim 12 wherein the first tube is attached to the side of the rod at the tip thereof.

15. The method of claim 12 wherein the length of the first tube is larger than the diameter of the first tube.

16. A fishing pole comprising:
a first rod portion comprising a handle for holding the fishing pole;
a rod extension extending at a first angle from the first rod portion, the rod extension having a length;
a second rod portion extending from an end of the rod extension, the second rod portion extending at a second angle from the rod extension;
a reel having fishing line attached to the second rod portion.

17. The fishing pole of claim 16 wherein the first rod portion and the second rod portion are roughly parallel to each other.

18. The fishing pole of claim 16 wherein the rod extension extends from the first rod portion at an angle of ninety degrees or less.

19. The fishing pole of claim 16 further comprising:
at least a first tube attached on a side of the rod in a first location between the reel and a tip of the rod at the second end thereof

20. The fishing pole of claim 19 wherein the first tube has a length that is larger than a diameter of the first tube.
